(19) United States
(12) Patent Application Publication
(10) Pub. No.: US 2003/0082297 A1
(43) Pub. Date: May 1, 2003

(54) Combustion turbine blade tip restoration by metal build-up using thermal spray techniques

(75) Inventors: Lutz Wolfgang Wolkers, Berlin (DE); Thomas J. Carr, Winter Springs, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 10/050,407

(22) Filed: Oct. 26, 2001

(51) Int. Cl. B05D 1/36; B05D 1/08

(52) U.S. Cl. 427/140; 427/404; 427/402; 427/419.2; 427/446

(57) ABSTRACT

A method of repairing the tip region of combustion turbine engine blades is provided. The method includes application of a thermal barrier coating after stripping of the bond coat, repair of the blade, reapplication of the bond coat and suitable heat treatment. Blades which previously were not coated with a thermal barrier coating are candidates for repair with the methods of the present invention.

### FIELD OF THE INVENTION

The present invention relates to a method of repairing hot section high performance nickel based turbine blade tips using thermal barrier coatings.

### BACKGROUND OF THE INVENTION

Components of gas turbine engines such as blades and vanes are exposed to a high stress environment which can include mechanical, thermal and rotational stressers. Turbine blades of the hot gas section in particular, especially rows 1 and 2, are known to be areas which are overheated, with some variability depending on the specific blade design and specific gas turbine. One means of preventing overheating of turbine blades and reducing the surface temperature of the tip and pocket is to increase the cooling air circulating on the blade; this can be achieved by drilling additional holes in the blade. However, many blades, even with the cooling holes, show wear and overheating in the tip area and the tip pocket of the blade after their first lifecycle in a combustion gas turbine engine. This leads to a high scrap rate of the blades due to the resulting material changes (oxidation, etc.) in this area.

Due to the high cost of high performance hot section turbine components, it is desirable to repair such components rather than replace them. A variety of methods currently exist for repairing gas turbine components.

U.S. Pat. No. 5,913,555 provides a method of repairing worn blade tips of compressor or turbine blades wherein the blade tip is removed, a repair part is machined and attached by welding or soldering.

U.S. Pat. No. 4,326,833 discloses a method for repair of gas turbine engine air cooled blade members which includes removing a blade segment from the blade, providing a replacement member of the same material, size and shape as the removed segment and metallurgically bonding the replacement member through non-fusion techniques.

U.S. Pat. No. 5,033,938 discloses a method of repairing turbine blades comprising removing damaged portions of the turbine blade and forming steel into a shape that conforms to the removed portion, and thereafter welding the insert into the turbine blade.

U.S. Pat. No. 5,822,852 provides a method for repairing blade tips using brazing or welding techniques.

U.S. Pat. No. 5,972,424 discloses a method of repairing turbine blade tips that have seen light wear using an abradable thermal barrier coating (TBC).

Other patents describe methods for applying thermal barrier coatings to the tip regions of turbine blades, but do not describe use of the TBC as a part of a method of repair. See, for example, U.S. Pat. No. 5,879,753, which discloses a method and apparatus for applying a thermal spray coating, and U.S. Pat. Nos. 5,059,095; 5,733,102; and 5,743,013, which describe specific thermal barrier coatings.

However, with many of the currently available methods of repair, repaired turbine blades are not usable at their optimal efficiency or the parts are not refurbishable for more than one time. For example, rewelding of the damaged region, especially of the tip pocket, is not a suitable solution, because stresses are likely to set up in the weld zone that can cause deterioration of the repaired section in operation. A redesign of the used parts is undesirable, due to the high cost of redesign, which also often results in the need for a redesign of other hot section components. New methods to provide repair of pre-existing gas turbine components continue to be sought.

### SUMMARY OF THE INVENTION

The present invention solves the above need and provides a method for repairing tips and tip pockets of gas turbine engine blades. Blades not previously having a thermal barrier coating in the initial design are candidates for the method of repair of the present invention. In contrast to prior art methods which use reapplication of the thermal barrier coating after light wear of the blade (less than a year of service or 800 hours), the present method can be used on parts that have seen significant service, or have significant failures in the tip region. These blades, and blades which have been sent back for a normal scheduled repair and maintenance cycle, are candidates for the repair method of the present invention. The method of the present invention provides a method of repair and optimization of blades, in that use of the thermal barrier coating minimizes the welding area in repair, thus allowing for more repair cycles and increasing the life-span of the part.

It is noted that the method of the present invention also increases the interval between repairs and makes future repairs easier to conduct.

To carry out the method of the present invention, the blade to be repaired is removed from service and the MCrAlY or other bond coat is stripped from the entire blade. The blade and tip region are inspected and repaired if necessary, after which the MCrAlY bond coat layer is reapplied, followed by suitable heat treatment of the entire blade. A non-abradable thermal barrier coating is then applied to the tip region of the blade on top of the MCrAlY bond coat.

The present invention provides a method of repairing blade tips in that the coating is applied to a small defined area of a blade which was previously not coated with a thermal barrier coating. The coating distribution (thickness and size of the area to be coated) is dependent upon the specific gas turbine region of the blade, and the method is most cost effective when used in repair of critical gas turbine blades. The coating can be used to reduce the need for additional cooling air as it provides a reduction in surface temperature of the blade and prevents overheating.

Additionally, a thermal barrier coating can improve the non-abradable quality of the tip, and reduce oxidation and corrosion of the tip region. This combination helps the blade perform over a longer life and/or more refurbishment cycles than in cases where the coating is not applied. The use of the given coating technology and materials rescues blades which would otherwise be scrapped and provides further usage.

Application of a thermal barrier coating provides an economic and easily carried out solution to the problem of repairing blade tips, because the gap between the tip and stator blade can be reduced to an optimal minimum size, thus increasing turbine efficiency. It can be assumed that with this design change the lifetime of the parts can be optimized, the overheating can be reduced, blade damage through overheating can be minimized and the necessity of cooling air reduced.

It is object of the present invention therefore, to provide a method for repairing the tip regions of gas turbine engine blades that would otherwise not be recyclable.

It is a further object of the present invention to provide a method for repairing the tip region of turbine engine blades by refurbishing the tip region with a thermal barrier coating.

It is an additional object of the present invention to provide an economical method of repairing turbine blade tips and tip pockets.

It is also an object of the present invention to provide a method for repairing the tip region of turbine engine blades that increases the interval between repairs and makes future repairs easier to conduct.

These and other objects of the invention will be more fully understood from the following detailed description and appended claims.

### BRIEF DESCRIPTION OF THE FIGURES

The invention is further illustrated by the following non-limited drawings in which:

FIG. 1 is a perspective view of a combustion turbine engine blade with a thermal barrier coating in the tip region.

### DETAILED DESCRIPTION OF PREFERRED EMBODIMENTS

The present invention relates to a method for repairing the tip region of a gas turbine engine blade comprising removing a turbine blade not previously coated with a thermal barrier coating from service and stripping the MCrAlY or other bond coat from the entire blade. The blade is then inspected for defects and repaired, as necessary. Following the repair an MCrAlY bond coat is re-applied to the entire blade, followed with suitable heat treatment. A non-abradable thermal barrier coating is then applied to the tip region of the blade on top of the MCrAlY bond coat.

As will be apparent to one skilled in the art, the first steps of preparing the blade tip include removing detachable details and other similar parts as appropriate. Other preliminary steps may include light dust blasting of the blade and visual inspection. After any preliminary steps, the MCrAlY bond coat is removed from the entire surface of the blade, typically by mechanical or chemical methods such as grinding, etching, use of acid baths, aluminizing methods, or other methods known in the art. Chemical methods of removal are preferred. Cooling holes are masked to protect against entrance of grinding or chemical media into the blade cooling passage. The blade is then heat tinted to verify removal of the bond coat.

The tip region may be inspected with techniques that include, but are not limited to, visual inspection, fluorescent penetrant inspection (FPI), x-ray inspection or any other appropriate method known to one skilled in the art to determine the presence of cracks and internal wall defects. The inspection criteria for the tip will depend on the particular blade being repaired. In some cases it may be permissible for the tip to have a small number of cracks. Some blades will not have the required minimum thickness, rendering the blade unsuitable for repair, although small repairs by welding may be appropriate.

After the tip has been inspected, it may be necessary to repair the blade to remove any undesirable cracks by welding, blending, or other similar methods. Recontouring by welding or brazing can be done as well. Recontouring of the welded material can be carried out by the electro-discharge machining (EDM) process. The repair is carried out on the complete blade.

Following repair the MCrAlY bond coating is reapplied to the entire blade, which is then subjected to diffusion and aging heat treatment. The bond coat may be deposited by any method known in the art, for example by low or reduced pressure plasma spray, air plasma spray, electron beam physical vapor deposition (EB-PVD, electroplating, cathodic arc, pack aluminide, overpack aluminide, or any other method known to one skilled in the art. Preferably the bond coat will be applied by air and vacuum plasma spray techniques.

The bond coat should be applied to the blade in a thickness to provide a strong bond between the blade and ceramic topcoat and to prevent cracks that develop in the ceramic topcoat from propagating into the blade. Preferably, the bond coat will be applied in a thickness between about 50-400 μm. In some situations where there has been strong oxidation of the blade or the tip has become too thin, a thicker MCrAlY layer may have to be applied. In such a situation a bond coat of between about 200-500 μm should be used.

Preferably, the bond coat is an MCrAlY, wherein the “M” stands for Fe, Ni, Co, or a mixture of Ni and Co. As used in the present invention, the term MCrAlY also encompasses compositions that include additional elements or combinations of elements such as Si, Hf, Ta, Re or noble metals known to those skilled in the art. The MCrAlY may also include a layer of diffusional aluminide, particularly an aluminide that comprises one or more noble metals. Preferably the bond coat will comprise about 30-34% Nickel, 19-23% Chromium, 6-10% Aluminum, 0.2-0.7% Yttrium, with the balance Cobalt.

Following heat treatment of the bond coat, a non-abradable thermal barrier coating is applied to the tip region of the blade on top of the MCrAlY bond coat. As used herein, the term “non-abradable” refers to a thermal barrier coating composition having small amounts of various oxides present in the coating mixture. The thermal barrier coating may comprise a mixture of partially stabilized zirconia, which is a mixture of zirconium oxide (ZrO2) and a stabilizer such as yttrium oxide (Y₂O₃), and lesser amounts of hafnium oxide (HfO₂), magnesium oxide (MgO) and calcium oxide (CaO) or mixtures thereof. Yttrium oxide is the preferred stabilizer. Most preferably the thermal barrier coating will comprise about 90-96% ZrO₂, about 4-10% Y₂O₃, about 2.0% or less of HfO₂, about 0.2% or less of MgO and CaO each, about 0% TiO₂, about 0.05% or less of U+Th, about 0.13% or less of Al₂O₃, and about 0.1% or less of Fe₂O₃.

For most applications, the thermal barrier coating will be between about 100-300 μm. Typically, the TBC will be the applied in the last 10 to 15 mm of the blade and in the blade tip pocket.

The thermal barrier coating of the present invention is deposited using methods known to those skilled in the art, including, but not limited to, air plasma spray methods, EP-PVD, vacuum plasma spraying and other methods known in the art.

Following deposition of the thermal barrier coating, the blade may be finished by a series of steps known in the art. For example, parts may need to be grinded to meet surface roughness requirements; in some cases, hand grinding, tumbling or blasting may be necessary. Preferably, the surface roughness will be about Ra=4 μm. If polymer masking has been used to protect the drilling holes during the coating process, heat treatment after coating will be required to burn out the polymer.

It is noted that this coating need not be applied only during repair; it may also be applied during fabrication, resulting in parts having increased reparability.

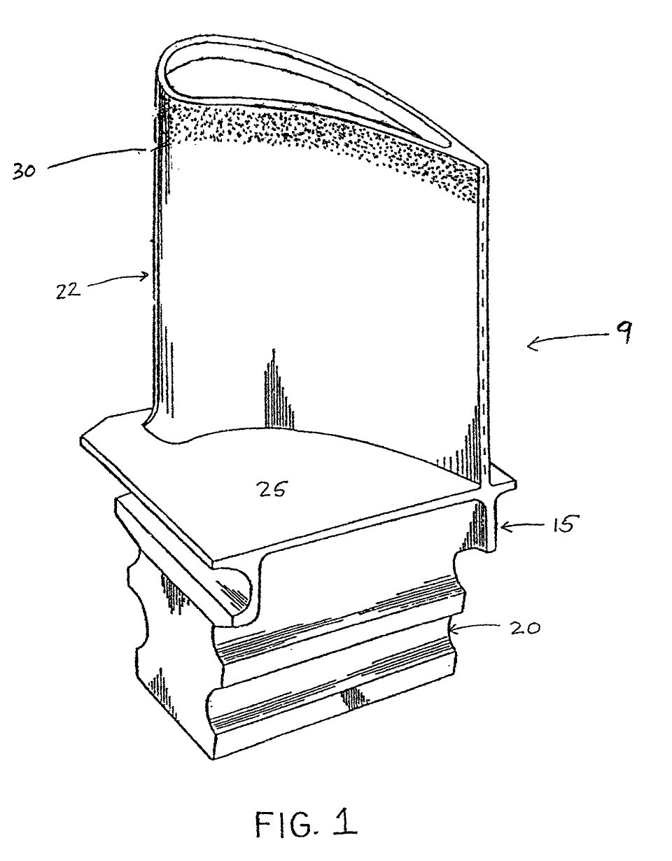

FIG. 1 shows a turbine engine hollow rotor blade, designated by the numeral 9. The blade 9 includes an airfoil 22, and a base 15 mounting the airfoil 22 to a rotor (not shown) of the engine (not shown). The base 15 has a platform 25 rigidly mounting the airfoil 22 and a dove tail root 20 for attaching the blade 22 to the rotor. The blade 9 is coated with a thermal barrier coating at the outer end portion 30.

### EXAMPLES

The following example is intended to illustrate the invention and should not be construed as limiting the invention in any way.

After visual inspection of the blade, the bond coat is removed by chemical stripping. A heat tint is used to verify complete coating removal. Next, visual or fluorescent penetrant inspection of the blade is carried out, followed by eddy current inspection of the leading and trailing edges, as well as a wall thickness check. Based upon the information gained from the various inspection methods a repair plan for blade is developed.

Next, all prepared areas of tip region are welded or brazed, followed by heat treatment if needed (only when a large amount of welding has been carried out). Grinding/milling/EDM/drilling of all repaired areas follows, as required, as well as recontouring of tip and leading/trailing edges by EDM, milling, or grinding processes. This includes size measurements and similar quality check processes.

The blade is then prepared for the coating process with pre-blasting or cleaning, as necessary. The MCrAlY is applied using vacuum or HVOF (vacuum plasma is preferred) methods. Heat treatment, including aging of the parts (base material dependent) follows application of the bond coat, as well as overspray grinding.

The non-abradable thermal barrier coating is then applied in the tip region, using APS. The coating comprises about 92-94% ZrO₂, about 6-8% Y₂O₃, about 2.0% or less of HfO₂, about 0.2% or less of MgO and CaO each, about 0% TiO₂, about 0.05% or less of U+Th, about 0.13% or less of Al₂O₃, and about 0.1% or less of Fe₂O₃.

When needed, polymer masking is used, and burnout heat treatment follows application of the TBC. Overspray grinding and surface grinding (hand grinding or blasting/tumbling (preferred) complete the processing requirements, followed by final inspection and quality-relevant measurements such as airflow, roughness, moment weigh, coating weight, coating thickness, and the like. Preferably, the surface roughness should be about Ra=4 μm.

Whereas particular embodiments of this invention have been described above for purposes of illustration, it will be evident to those skilled in the art that numerous variations of the details of the present invention may be made without departing from the invention as defined in the appending claims.

What is claimed is:

1. A method for repairing the tip region of a gas turbine engine blade comprising:
removing from service a turbine blade not previously having a thermal barrier coating;
stripping the MCrAlY or other bond coat of the entire blade;
inspecting the blade;
repairing the blade;
applying an MCrAlY bond coat layer followed by suitable heat treatment of the entire blade; and
applying a non-abradable thermal barrier coating to the tip region of the blade.

2. The method of claim 1, wherein the thermal barrier coating is applied on the suction and pressure side of the blade.

3. The method of claim 1, wherein the thermal barrier coating is applied in the last 10 to 15 mm of the blade and in the blade tip pocket.

4. The method of claim 1, wherein the MCrAlY coating thickness is between about 50-400 μm.

5. The method of claim 1, wherein the thermal barrier coating is comprised of a partially stabilized zirconia.

6. The method of claim 1, wherein the thermal barrier coating is applied using vacuum plasma spray methods.

7. The method of claim 1, wherein the thermal barrier coating is applied in a thickness of between about 100-300 μm.
